(19) United States
(12) Patent Application Publication
(10) Pub. No.: US 2018/0059898 A1
(43) Pub. Date: Mar. 1, 2018

(54) Platform to Create and Disseminate Virtual User Experiences

(71) Applicant: Adobe Systems Incorporated, San Jose, CA (US)

(72) Inventors: Gavin Stuart Peter Miller, Los Altos, CA (US); Nadia Rehman-Murphy, San Jose, CA (US); Cory Lynn Edwards, Highland, UT (US); Peter Raymond Fransen, Soquel, CA (US)

(73) Assignee: Adobe Systems Incorporated, San Jose, CA (US)

(21) Appl. No.: 15/246,137

(22) Filed: Aug. 24, 2016

(51) Int. Cl. G06F 3/0481; H04L 29/06; G06Q 30/02

(52) U.S. Cl. CPC G06F 3/04815; G06Q 30/0275; H04L 67/38

(57) ABSTRACT

Techniques and systems are described to implement a platform to create and disseminate virtual user experiences. In one example, a service provider exposes a platform usable for creation of virtual user experiences. In another example, a service provider exposes functionality to enable specification of physical environment conditions to be met in order to cause dissemination of respective virtual user experiences maintained by the service provider. In one instance, triggers are detected by a computing device of a user that are indicative of a likelihood to cause output of a virtual user experience. Once triggered, the computing device communicates data describing physical environment conditions to the service provider. The service provider then matches these conditions to specified physical environment conditions that are to be used to control dissemination of the virtual user experience.

### BACKGROUND

Virtual user experiences are usable as part of augmented and virtual reality scenarios to support output of virtual objects to be rendered for viewing by users. In an augmented reality scenario, the virtual objects are used to augment a user's direct view of the physical environment in which the user is disposed. The user, for instance, may view the physical environment through a display device and have virtual objects that are a part of a game appear as if placed on surface within the physical environment. In a virtual reality scenario, on the other hand, an entirety of what is viewed by the user is created using virtual objects. The virtual objects may represent physical objects included in the physical environment of the user as well as additional objects that are added to this environment.

Conventional techniques that are used to provide these virtual user experiences, however, are focused on a proprietary stack of hardware and software experiences where the experiences are tailored for each different device. Accordingly, there is a need for a new way of developing virtual user experiences that go beyond the current proprietary hardware/software solutions.

### SUMMARY

Techniques and systems are described to implement a platform to enable creation and dissemination a plurality of virtual user experiences. In one example, the platform is configured to aid a developer in creation of a virtual user experience for output as part of an augmented or virtual reality environment that is usable across a variety of types of computing devices. To do so, a capability matrix is generated that describes capabilities of these different types of devices. This may include description of output and input devices usable as part the experience and capabilities of those devices. This capability matrix is then used to determine commonalities across the types of devices, which are then used to define a platform via which the developer can code to create the virtual user experience that will function across at least a subset of these devices, e.g., as a lowest-common denominator of functional support.

The capabilities matrix may also define relationships between functionalities and references to respective types of devices. These relationships, for instance, may enable the platform to support creation of virtual user experiences for particular device types, as well as to migrate these experiences to different device types. For example, the creation of the virtual user experience may be defined as part of the platform as paths to obtain a desired action, e.g., a button of a controller to perform a zoom. Different paths may then be defined and utilized to migrate the virtual user experience to different types of devices as well as address emerging technologies, e.g., a gesture performed “in the air” and detected using a camera to perform the zoom. In this way, the platform may enable the virtual user experience to mutate to support different device types.

In another example, a service provider specifies functionality of physical environment conditions which must be met in order to cause dissemination of respective virtual user experiences maintained by the provider. The specification of conditions for triggering the virtual user experience allow independent virtual experience creators to create their own experiences with confidence that the experience will work properly across a variety of devices. In addition, when a user meets the application trigger, the experience is launched in a predictable and reliable way, which will facilitate interaction and adoption by the user.

In one implementation, a monetary amount (e.g., bid) is specified and used as a basis, at least in part, to control which virtual user experiences are disseminated to each computing device based on physical environment conditions reported by the device. In this way, a logically centralized location (e.g., a platform/clearinghouse) may be provided via which these virtual user experiences are managed for dissemination.

Users may thus obtain these virtual user experiences from this centralized location. In one example, triggers are detected by a computing device of a user that are indicative of a likelihood to cause output of a virtual user experience. Once triggered, the computing device communicates data describing physical environment conditions to the service provider. The service provider then matches these conditions to specified physical environment conditions that are to be used to control dissemination of the virtual user experience back to the computing device.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques to control dissemination of virtual user experiences described herein.

FIG. 2 depicts a system in an example implementation in which a platform manager module exposes functionality to create virtual user experiences for dissemination to a user.

FIG. 3 depicts a system in an example implementation in which virtual user experiences are received by the service provider along with specification of physical environment conditions that are to be used to control dissemination of the experiences.

FIG. 4 depicts a system in an example implementation in which dissemination of virtual user experiences is controlled by a service provider of FIG. 1 based at least in part of physical environment conditions of a potential recipient of the experiences.

FIG. 5 depicts an example implementation of a view of the user of FIG. 1 as including a virtual user experience within a physical store.

FIG. 6 depicts an example implementation in which a trigger of location as proximal to a physical store is used to cause output of virtual user experiences selected based on user data.

FIG. 7 depicts an example implementation in which a virtual user experience selected for a first user is based on proximity to a second user.

FIG. 8 is a flow diagram depicting a procedure in an example implementation in which virtual user experiences are associated with specified physical environment conditions to be used to control dissemination.

FIG. 9 is a flow diagram depicting a procedure in an example implementation in which dissemination is controlled of virtual user experiences.

FIG. 10 is a flow diagram depicting a procedure in an example implementation in which a platform is configured for creation of a virtual user experience.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

Overview

Techniques and systems are described to provide a platform to create and disseminate virtual user experiences. Virtual user experiences may be output in virtual or augmented reality scenarios to support an entirety of a user's view or augment a user's view of a physical environment, respectively. Through use of the platform, creation and dissemination of the virtual user experiences may be centrally managed across a variety of different computing devices.

In one example, the platform is configured to aid a developer in creation of a virtual user experience for output as part of an augmented or virtual reality environment that is usable across a variety of types of computing devices. To do so, a capability matrix is generated that describes capabilities of these different types of devices. This may include description of output devices usable to output the experience, such as display resolutions, fields of view, audio support, and so forth. Input devices may also be described, such as support for eye tracking, controllers, gestures, spoken utterances, and so forth. This capability matrix is then used to determine commonalities across the types of devices, which are then used to define a platform via which the developer can code to create the virtual user experience that will function across at least a subset of these devices, e.g., as a lowest-common denominator of functional support. Developers may then decide, through interaction with the matrix, additional functionality as described that may be “built on top of” or “coded separately” from this baseline virtual user experience as desired by business or usage goals. The developer, for instance, may decide to provide additional functionality that may be “wrapped” to the baseline virtual user experience to support additional functionality for a common device type.

The capabilities matrix may also define relationships between functionalities and references to respective types of devices. These relationships, for instance, may enable the platform to support creation of virtual user experiences for these device types, as well as to migrate these experiences to different device types. For example, the creation of the virtual user experience may be defined as part of the platform as paths to obtain a desired action, e.g., a button of a controller to perform a zoom. Different paths mat then be defined and utilized to migrate the virtual user experience to different types of devices as well as address emerging technologies, e.g., a gesture performed “in the air” and detected using a camera to perform the zoom. In this way, the platform may enable the virtual user experience to mutate to support different device types, further discussion of which is included in a corresponding section in the following.

In another example, a service provider collects virtual user experiences from creators of the experiences via a network. The service provider also exposes functionality to enable the creators of these experiences to specify physical environment conditions to be met in order to cause dissemination of respective experiences. In this way, a centralized location may be provided via which these virtual user experiences are managed for dissemination.

Users may thus obtain these virtual user experiences from this centralized location in a variety of ways. In one example, a user wears a head mounted computing device (e.g., goggles) when walking through a physical store, down the street, and so on. The computing device includes a user experience manager module (e.g., a browser) that is configured to monitor a physical environment in which the computing device is disposed, such as through use of a camera for object recognition, radar techniques, beacon techniques, and so forth.

Based on this monitoring, the user experience manager module detects triggers that are indicative of a likelihood to cause output of a virtual user experience. The triggers, for instance, may be downloaded to the user experience manager module from a service provider that provides the platform above. Examples of such triggers include particular company logos, triggers based on analytics and machine learning that is usable to identify which virtual user experiences are likely of interest to the user, visual codes (e.g., QR and bar codes), and so forth. In other instance, the triggers are based on monitored user interactions, e.g., picking up a particular good, gazing at particular types of goods or services, and so forth.

Once triggered, the computing device communicates data describing physical environment conditions to the service provider as well as any other additional data that may be pertinent to the service provider. The service provider, as before, may then match these conditions to specified physical environment conditions that are to be used to control dissemination of the virtual user experience. The computing device then receives the disseminated virtual user experiences and renders it for viewing by the user. The virtual user experience, for instance, may be output for a defined amount of time. In one example, the virtual user experience includes functionality to indicate a “safe location” that may be used to interact with the experience, e.g., on the side of an aisle, sidewalk, and so forth and thus protect the user from potential harm. In this way, a variety of different virtual user experiences may be made readily available to users, additional examples of which are included in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

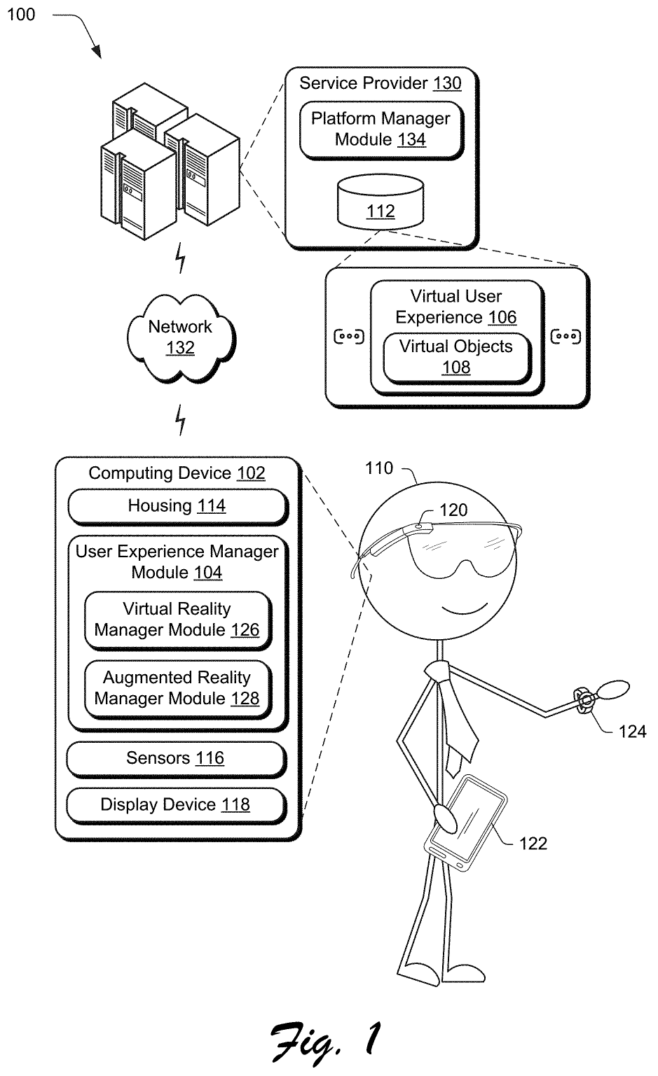

FIG. 1 is an illustration of an environment 100 in an example implementation that is operable to employ techniques described herein. The illustrated environment 100 includes a computing device 102 configured for use in augmented reality and/or virtual reality scenarios, which may be configured in a variety of ways.

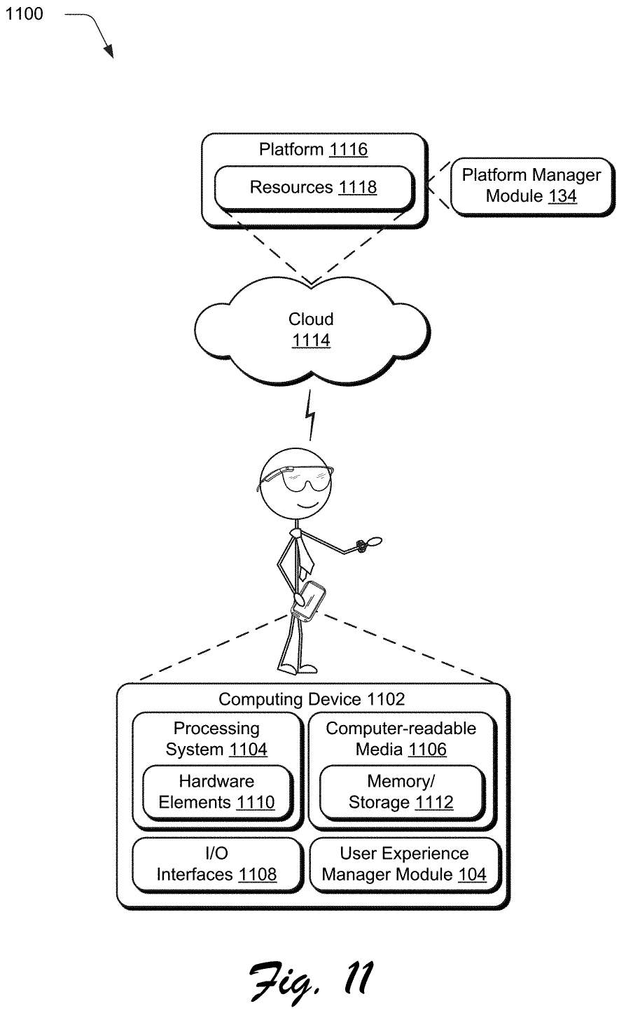

The computing device 102 is illustrated as including a user experience manager module 104 that is implemented at least partially in hardware of the computing device 102, e.g., a processing system and memory of the computing device as further described in relation to FIG. 11. The user experience manager module 104 is configured to manage output of and user interaction with a virtual user experience 106 having one or more virtual objects 108 that are made visible to a user 110. The virtual user experience 106 and one or more virtual objects 108 are illustrated as maintained in storage 112.

The computing device 102 includes a housing 114, one or more sensors 116, and a display device 118. The housing 114 is configurable in a variety of ways to support interaction with the virtual user experience 106. In one example, the housing 114 is configured to be worn on the head of a user 110 (i.e., is “head mounted” 120), such as through configuration as goggles, glasses, contact lens, and so forth. In another example, the housing 114 assumes a hand-held 122 form factor, such as a mobile phone, tablet, portable gaming device, and so on. In yet another example, the housing 114 assumes a wearable 124 form factor that is configured to be worn by the user 110, such as a watch, broach, pendant, or ring. Other configurations are also contemplated, such as configurations in which the computing device 102 is disposed in a physical environment apart from the user 110, e.g., as a “smart mirror,” wall-mounted projector, television, and so on.

The sensors 116 may also be configured in a variety of ways to detect a variety of different physical environment conditions of the computing device 102. In one example, the sensors 116 are configured to detect an orientation of the computing device 102 in three-dimensional space, such as through use of accelerometers, magnetometers, inertial devices, radar devices, and so forth. In another example, the sensors 116 are configured to detect environmental conditions of a physical environment in which the computing device 102 is disposed, such as objects, distances to the objects, motion, colors, and so forth. Examples of which include cameras, radar devices, light detection sensors (e.g., IR and UV sensors), time of flight cameras, structured light grid arrays, barometric pressure, altimeters, temperature gauges, compasses, geographic positioning systems (e.g., GPS), and so forth. In a further example, the sensors 116 are configured to detect environmental conditions involving the user 110, e.g., heart rate, temperature, movement, and other biometrics.

The display device 118 is also configurable in a variety of ways to support the virtual user experience 106. Example of which include a typical display device found on a mobile device such as a camera or tablet computer, a light field display for use on a head mounted display in which a user may see through portions of the display, stereoscopic displays, projectors, and so forth. Other hardware components may also be included as part of the computing device 102, including devices configured to provide user feedback such as haptic responses, sounds, and so forth.

The housing 114, sensors 116, and display device 118 are also configurable to support different types of virtual user experiences 106 by the user experience manager module 104. In one example, a virtual reality manager module 126 is employed to support virtual reality. In virtual reality, a user is exposed to an immersive environment, the viewable portions of which are entirely generated by the computing device 102. In other words, everything that is seen by the user 110 is rendered and displayed by the display device 118 through use of the virtual reality manager module 126.

The user, for instance, may be exposed to virtual objects 108 that are not “really there” (e.g., virtual bricks) and are displayed for viewing by the user in an environment that also is completely computer generated. The computer-generated environment may also include representations of physical objects included in a physical environment of the user 110, e.g., a virtual table that is rendered for viewing by the user 110 to mimic an actual physical table in the environment detected using the sensors 116. On this virtual table, the virtual reality manager module 126 may also dispose virtual objects 108 that are not physically located in the physical environment of the user 110, e.g., the virtual bricks as part of a virtual playset. In this way, although an entirely of the display being presented to the user 110 is computer generated, the virtual reality manager module 126 may represent physical objects as well virtual objects 108 within the display.

The user experience manager module 104 is also illustrated as supporting an augmented reality manager module 128. In augmented reality, the virtual objects 108 are used to augment a direct view of a physical environment of the user 110. The augmented reality manger module 128, for instance, may detect landmarks of the physical table disposed in the physical environment of the computing device 102 through use of the sensors 116, e.g., object recognition. Based on these landmarks, the augmented reality manager module 128 configures a virtual object 108 of the virtual bricks to appear as is placed on the physical table.

The user 110, for instance, may view the actual physical environment through head-mounted 120 goggles. The head-mounted 120 goggles do not recreate portions of the physical environment as virtual representations as in the VR scenario above, but rather permit the user 110 to directly view the physical environment without recreating the environment. The virtual objects 108 are then displayed by the display device 118 to appear as disposed within this physical environment. Thus, in augmented reality the virtual objects 108 augment what is “actually seen” by the user 110 in the physical environment. In the following discussion, the virtual user experience 106 and virtual objects 108 of the user experience manager module 104 may be used in both a virtual reality scenario and an augmented reality scenario.

The environment 100 is further illustrated as including a service provider 130 that is accessible to the computing device 102 via a network 132, e.g., the Internet. The service provider 130 includes a platform manager module 134 that is implemented at least partially in hardware of a computing device (e.g., one or more servers) to managed a virtual user experience platform. The platform manager module 134, for instance, may provide functionality to accept, store, and disseminate virtual user experiences 106.

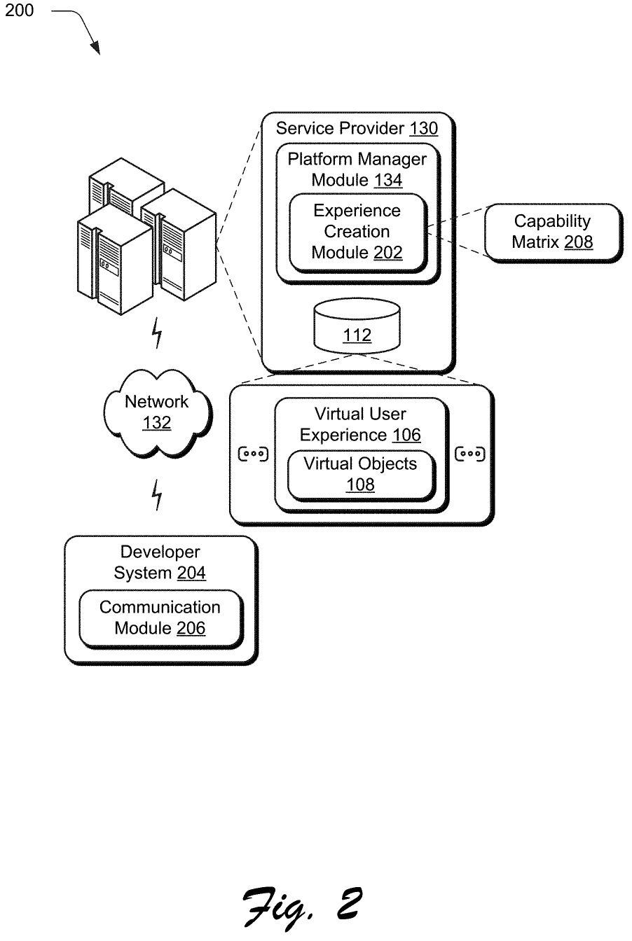

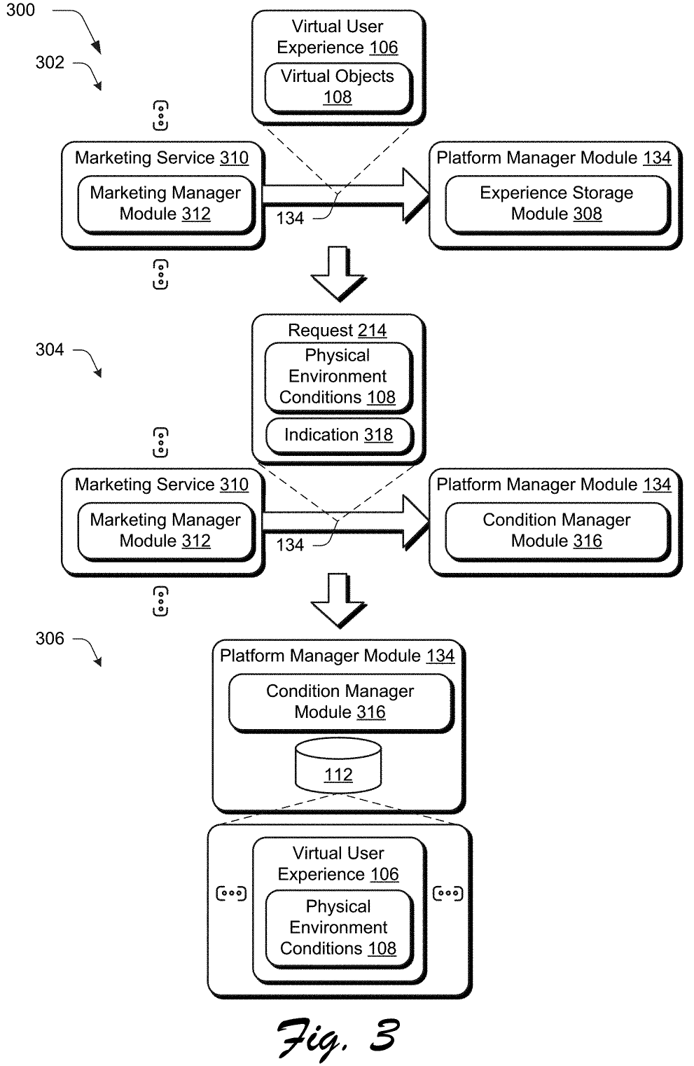

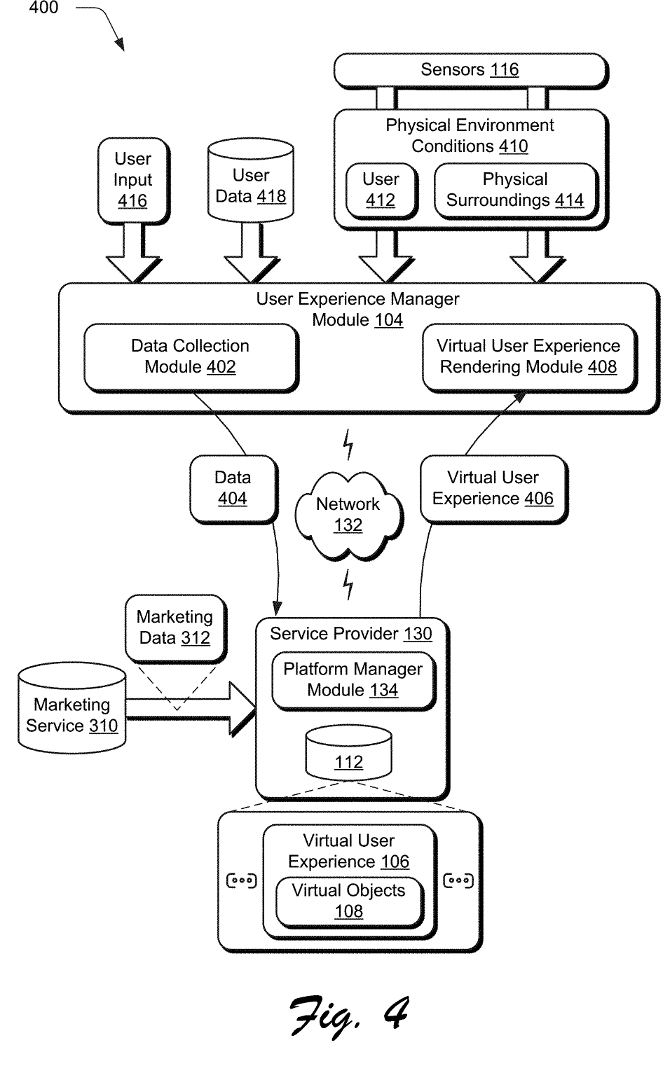

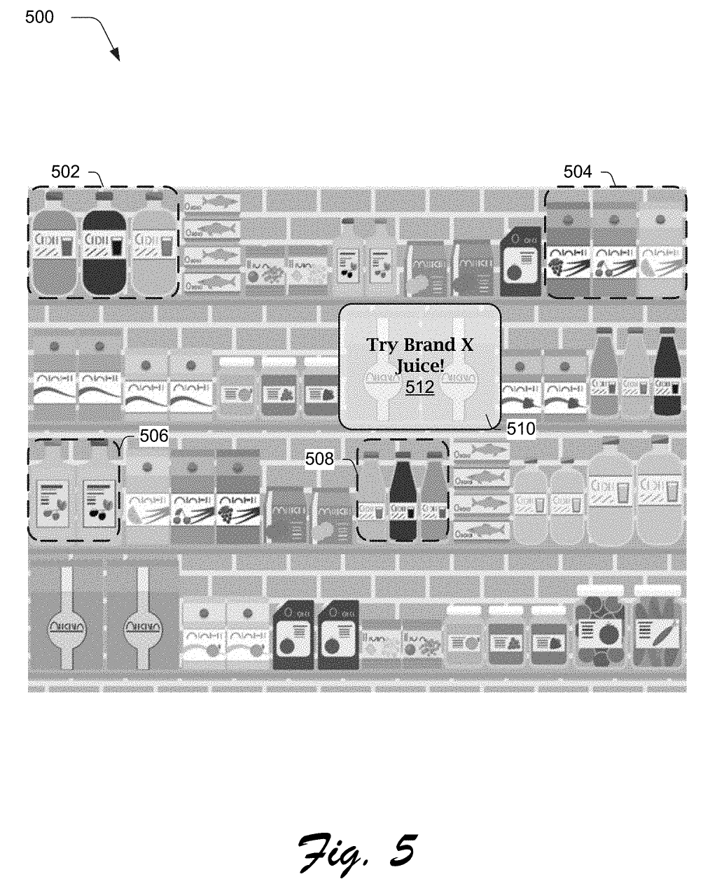

The platform manager module 134, for instance, includes functionality to create virtual user experiences 106 as described in relation to FIG. 2. The platform manager module 134 also includes functionality to control dissemination of the virtual user experiences 106 to a computing device 102 of a user 110 based on physical environment conditions. An example of receipt of virtual user experiences 106 is described in relation to FIG. 3. An example of control of dissemination of the virtual user experiences 106 is described in relation to FIG. 4, with illustrations of different usage scenarios shown in FIGS. 5-7.

Creation of Virtual User Experiences

FIG. 2 depicts a system 200 in an example implementation in which the platform manager module 134 exposes functionality to create virtual user experiences 106 for dissemination to the user 110. The platform manager module 134 in this instance includes an experience creation module 202. The experience creation module 202 is implemented at least partially in hardware of a computing device to expose functionality that is usable by a user through interaction with a developer system 204 to create a virtual user experience 106. Although illustrated as implemented by the service provider 130 and accessible remotely through use of a communication module 206 (e.g., browser, application, and so on) of the developer system 204 through use of at least one computing device, this functionality may also be implemented in whole or in part locally by the developer system 204.

The experience creation module 202 is configured to enable a user of the developer system 204 to generate the virtual user experience 106 to address differences in capabilities available from different types of devices used to output the experiences. For example, a computing device configured support augmented reality has an ability to add digital content within a physical environment but does not have an ability to provide a fully immersive environment as encountered in a virtual reality environment. Accordingly, the experience creation module 202 is configured to address these differences in order to enable a user of the developer system 204 to create a virtual user experience 106 that is consumable by different types of devices.

To do so in this example, the experience creation module 202 employs a capability matrix 208. The capability matrix 208 is used to quantify and define differences in capabilities of computing devices 102 that are to be used to output the virtual user experience 106 as well as a relationship between these capabilities. As part of this, the capability matrix 208 defines differences in capabilities within categories of functionality. For a display device category, for instance, the capability matrix 208 may define differences in resolutions, fields of view (angular amounts of a user's environment that are available from the display device), ranges of colors, and so forth. Similar capabilities may be defined for audio devices, e.g., support of monaural or stereo support, haptic output devices, and so forth.

The range of input devices supported by computing devices 102 to provide user interaction with the virtual user experience 106 may have an even greater variety. To address this, categories of capabilities may be defined by a type of input used in addition to features of the devices used to support the type of input. A gesture category, for instance, may be defined to recognize gestures that are detected using a camera as part of a natural user interface. Other types of detection of gestures may be defined using other categories, such as use of a trackpad, touchscreen functionality of a display device, and so forth. Specific types of gestures may also be defined within these categories or separately as their own category regardless of how the gesture is detected, such as “grabs,” “drag and drop,” and so forth. A controller category may also be defined, with different types of inputs supported by this category defined, e.g., keyboards (QWERTY), specific buttons, trackpads, joysticks, detected movement in three-dimensional space (e.g., X/Y, X/Y/Z, rotational), radar devices, accelerometers, eye tracking, inertial detection devices, and so forth.

The categories, and capabilities within the categories, may also be grouped to define capabilities supported by different computing devices from different manufacturers. The experience creation module 202, for instance, may expose a software developer kit (SDK) as part of the platform via which a user of the developer system 204 may interact to code the virtual user experience 106 for use by desired devices. A lowest common denominator option may also be provided to code a virtual user experience 106 that is consumable across multiple types of devices. For example, the lowest common denominator option may be provided by the experience creation module 202 to support display and interaction that is common to all or a subset of selected manufacturers of computing devices and associated software that is used to consume the virtual user experience 106. This may include use of open display standards and limitations of types of inputs, if any, used to interact with the virtual user experience 106. Additionally, this option may also be configured dynamically based on observed commonalities across different types of devices to address subsequent changes made to these devices, e.g., increased resolutions, increased commonality of different types of inputs, and so forth based on minim thresholds of commonality that once met are used to modify the platform.

The user of the developer system 204 may then first code a virtual user experience 106 that is consumable across the range of devices. The user of the developer system 204 may then decide how much additional coding is desired to be undertaken to address differences in capabilities across the devices through use of the capability matrix 208 and grouping for specific computing device types. For example, the user of the developer system 204 may target certain types of computing devices that are more common than other types of devices.

The experience creation module 202 may also be configured to adapt a virtual user experience 106 (e.g., automatically and without user intervention) for use by different types of devices as well as to address emerging technologies. This may be performed based on defined relationships between categories and desired actions corresponding to input received according to these categories.

The experience creation module 202, for instance, may expose the platform such that a user of the developer system 204 defines an action to be performed by the computing device 102 (e.g., zoom, navigation, display, and so forth) as part of the virtual user experience 106. A path that is to be undertaken to perform that action may then be defined, such as to press a button on a controller to open an item. The experience creation module 202, by leveraging the capability matrix 208, may then define other paths to achieve that same action based on capabilities of different devices and/or use defined relationships within the capability matrix 208. For example, a pinch gesture detected via a natural user interface using a camera for one type of computing device may be used as a proxy for the pressing of the button on a controller of another type of computing device. In this way, a user of the developer system 204 may quickly adapt a virtual user experience 106 coded for one type of device for use with another type of device through interaction with the experience creation module 202.

In one example, this adaptation is performed automatically and without user intervention by the experience creation module 202 to update the virtual user experience 106 in response to monitored changes within the capabilities matrix 208. The virtual user experience 106, for instance, may be configured to perform an action based on a particular type of input. As different types of inputs are developed, the capabilities matrix 208 may be updated to include these types as well as a relationship to other types of inputs included in the matrix to perform this action. Based on this update, the virtual user experience 106 is updated by the experience creation module 202 to address this change and thus leverage this newly available functionality.

As part of this adaptation, the experience creation module 202 may implement techniques that define how the virtual user experience 106 is to mutate through use of responsive design. This may include standardization of how digital content of the virtual user experience 106 is to be captured, stored, and rendered to address differences in capabilities, such as device resolutions, types of inputs, formatting, and so on as described above. The experience creation module 202 may then “wrap” the virtual user experience 106 using feature flags that define the actions to be performed such that different paths may be subsequently developed as described above. In this way, the experience creation module 202 may address differences between existing devices and even subsequently developed devices to enable the virtual user experience 106 to be output by these devices by providing an ability to mutate the virtual user experience 106.

In one example of such an adaptation by the experience creation module 202, consider a virtual user experience 106 configured for viewing as part of an augmented reality environment, such as to “Try Brand X Juice!” 512. As part of creating this virtual user experience, a user of the developer system defines a location at which to output the experience based on triggers within a physical environment of the user, e.g., a height from a floor and distance from a wall. In a virtual reality environment, however, these triggers are not available. Accordingly, the experience creation module 202 is configured to convert the location within the physical environment to a location within the virtual environment, e.g., as a field of view calculation to act as a proxy for the ground and wall above. Other examples are also contemplated to support different input or output types. In this way, the experience creation module 202 supports creation of a virtual user experience 106, the use of which may be supported by a range of heterogeneous devices and may adapt to subsequently developed devices.

Dissemination Control of Virtual User Experiences

FIG. 3 depicts a system 300 in an example implementation in which virtual user experiences 106 are received by the service provider 130 along with specification of physical environment conditions 108 that are to be used to control dissemination of the experiences. This system 300 is illustrated using first, second, and third stages 302, 304, 306.

At the first stage 302, an experience storage module 308 of the platform manager module 134 is implemented at least partially in hardware to manage receipt and storage of virtual user experiences 106. In one example, the experience storage module 308 exposes a user interface that is accessible via the network 134 by a variety of different entities.

In the illustrated instance, the user interface is exposed to a marketing service 310. The marketing service 310 includes a marketing manager module 312 that accesses the user interface to cause communication of the virtual user experience 106. The virtual user experience 106, for instance, may be configured as an advertisement for a particular brand of good or service. Other examples are also contemplated, such as to support access directly from a creator of the virtual user experience 106, to a corresponding manufacturer or provider of the good or service to which the virtual user experience 106 pertains, a virtual fitting experience of online shoppers in which virtual objects 108 are used to represent goods that may be “tried on” and then purchased by a user (and thus save shipping costs for returned goods), and so forth.

At the second stage 304, a request 314 is received by a condition manager module 316. The request 314 specifies physical environment conditions 108 to be met to cause output of a respective virtual user experience 106. The condition manager module 316, for instance, may expose a user interface that is usable by the marketing service 310 to select from a predefined list of physical environment conditions 108. This may include physical environment conditions of a user (e.g., biometrics, identity, segment of population, demographics) of the computing device 102. This may also include physical environment conditions of a physical environment in which the computing device 102 is disposed as well as other conditions as further described in relation to FIG. 4. Thus, the physical environment conditions may describe a greater range of usage scenarios by describing a physical environment, and not just online usage scenarios as performed by conventional techniques.

As part of specification of the physical environment conditions 108, the request 314 also includes an indication 318 to be used as calculation of a monetary amount to be paid to the service provider 130 for dissemination of the virtual user experience 106. The condition manager module 316, for instance, may expose a user interface. Interaction with this user interface may be used to specify an amount of money to be paid to the service provider 130 to disseminate the virtual user experience 106 to the computing device 102 of the user 110; disseminate and render; disseminate, render, and receive a subsequent user interaction (conversion); and so forth. Thus, in this example the virtual user experience 106 may be configured as marketing digital content, dissemination of which is paid for by the marketing service 310, corresponding provider of a good or service being advertised, and so forth. The virtual user experience 106, for instance, may support additional information related to a brand of shoe which is to be output when physical environment conditions 108 are detected that include that brand of shoe, a competitor of that brand, and so forth.

In another instance, the virtual user experience 106 may be configured to include advertisements. Accordingly, the indication 318 may specify availability of these opportunities, which may also be the subject of bids by the condition manager module 316. A virtual user experience 106, for instance, may be configured to support additional information relating to a sporting event. This virtual user experience 106 may also include opportunities to include additional virtual objects 108, e.g., advertisements of sporting goods, snack foods, and so forth. These opportunities may also be “put up for bid” by the condition manager module 316, and thus in this instance the virtual user experience 106 also provides additional revenue opportunities to the service provider 130, a provider of the virtual user experience 106 that supports inclusion of these other virtual objects 108, and so forth. A variety of other instances are also contemplated without departing from the spirit and scope thereof.

At the third stage 306, the condition manager module 316 associates the virtual user experience 106 with the physical environment conditions 108 that are to be used as a basis to control dissemination of the experiences. Dissemination of these experiences may also be based on the indication 318 of the monetary amounts. For example, the indication 318 may be used to specify that a particular virtual user experience 106 is to be disseminated each time those physical environment conditions 108 are met, a frequency at which this dissemination is to occur (e.g., higher pay resulting in a greater frequency), and so forth. Further discussion of dissemination control is included in the following.

FIG. 4 depicts a system 400 in an example implementation in which dissemination of virtual user experiences 106 is controlled by a service provider 102 based at least in part of physical environment conditions 310 of a potential recipient of the experiences. In this example, the user experience manager module 104 incorporates a data collection module 402 that is configured to collect data 404 that is to be used as a basis to select a virtual user experience 106 by the service provider 130. The data collection module 402, for instance, may include functionality in which the user 110 “opts in” to collection and communication of this data 404 to the service provider 130. In return for this, the user experience manager module 104 receives a virtual user experience from the service provider 130 that is rendered by a virtual user experiences rendering module 408, e.g., as part of an augmented or virtual reality scenario.

The data 404 collected by the data collection module 402 may describe a variety of characteristics of a user 110 that is to consume the virtual user experience 106, how the virtual user experience 106 is to be consumed, and so forth. In one example, the user experience manager module 104 receives inputs from sensors 116 of the device 102. The sensors 116, as previously described, may describe physical environment conditions 410 that pertain to a user 412 of the computing device 102, physical surroundings 414 of an environment in which the computing device 102 is disposed, and so forth.

The physical environment conditions 410, for instance, may describe physical characters of the user 110, e.g., biometrics such as heart rate, activity level, and so forth. In another instance, the physical environment conditions 410 describe user interactions with physical goods or services. The sensors 116 in this instance may be configured as a front-facing camera, radar devices, and so forth that are capable of recognizing particular physical goods or services, e.g., via object recognition, use of unique identifiers (e.g., QR or bar codes, company logos), and so forth.

From this, the data collection module 402 may determine which physical goods or services the user has expressed interest in, such as goods that are picked up by the user 110 or gazed at over a threshold amount of time. The data collection module 402 may also determine which physical goods or services that the user 110 has expressed disinterest, such as physical characteristics in how the user has handled a good (slammed it back down), made a verbal utterance (e.g., a sound of the user scoffing at a price), etc. Other examples are also contemplated, such as a location within one or more physical stores (e.g., a single store, a shopping mall, and so on) detected using positioning functionality at the physical stores, e.g., signals emitted or collected by position determination functionality incorporated as part of light fixtures. The physical environment conditions 410 may thus leverage detection performed by the computing device 102 as part of support of an augmented or virtual reality scenario to provide data 404 having increased richness of online techniques.

A variety of other characteristics may also be incorporated as part of the data 404 used by the platform manager module 134 as part of selection of the virtual user experience 406 from the plurality of virtual user experiences 106. In one example, a user input 416 is used as part of the selection, such as text input using text to speech functionality based on a spoken utterance of the user 110 to be used as part of a search. In another example user data 418 is employed, e.g., that describes physical characteristics of the user, user demographics, identity of the user (e.g., user name, user account information), user associations (e.g., other users such as family or friends), and so forth. This user data 418 may be obtained locally from the user experience manager module 104, by the service provider 140 itself (e.g., as part of an online profile), from a third-party service (e.g., a social network), and so on.

In a further example, the service provider 140 leverages marketing data 312 obtained by a marketing service 310. The marketing data 312, for instance, may be used to classify the user 110 into a respective marketing segment based on similarity of the user to other users. Machine learning is employed by the marketing service 310 to train a model to determine which virtual user experiences 106 result in conversion of goods or services for these segments. Accordingly, this model may then be used as a basis to select from the virtual user experience 106, e.g., based on the data 404, through membership of the user 110 in a respective segment. This and other data 404 may be used to support a variety of different usage scenarios, examples of which are described in the following.

FIG. 5 depicts an example implementation 500 of a view of the user 110 of FIG. 1 as including a virtual user experience 106 within a physical store. In this example, data 404 of FIG. 4 is collected that describes goods that are disposed in a physical environment of the user 110, which includes a selection of juices 502, 504, 506, 508, 510. Thus, the data indicates that the user 110 is likely interested in purchasing juice. From this data, the service provider 130 also determines that a particular brand of juice is available. In response, a virtual user experience is displayed to prompt the user 110 to try Brand X juice 512. This virtual user experience may be configured to “time out” after a predefined amount of time which may be associated as part of the virtual user experience, e.g., to remove after 5 seconds, once a user has expressed disinterest (e.g., “looked away”), and so forth.

Positioning of a display the virtual user experience is anchored to the label of the juice 510, which is this case is partially transparent over the juice but other examples are also contemplated, such as proximal to the juice 510. The virtual user experience may be configured in a variety of ways, such as a static image, animation, and so forth. In this way, user 110 engagement with the juice may be promoted.

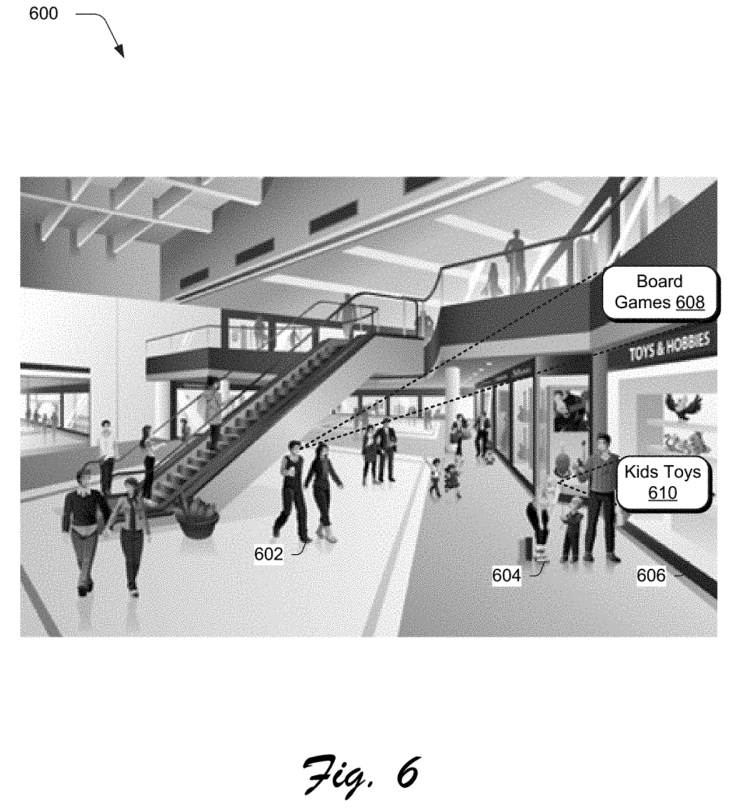

FIG. 6 depicts an example implementation 600 in which a trigger of location as proximal to a physical store is used to cause output of virtual user experiences selected based on user data 418. In this example, first and second users 602, 604 view a toy and hobby store 606. This triggers respective computing devices to communicate data to the service provider 130 for receipt of virtual user experiences.

In this example, the data identifies the respective users, which is then used to select appropriate virtual user experiences 106. For the first user 602 that does not have children, a virtual user experience 608 indicating availability of board games from the physical store 606 is output. For the second user 604 that does have a child, however, availability of kids toys 610 is indicated through a respective virtual user experiences. Thus, each of these users is provided with a custom-tailored experience have an increased likelihood of resulting in a conversion for that user.

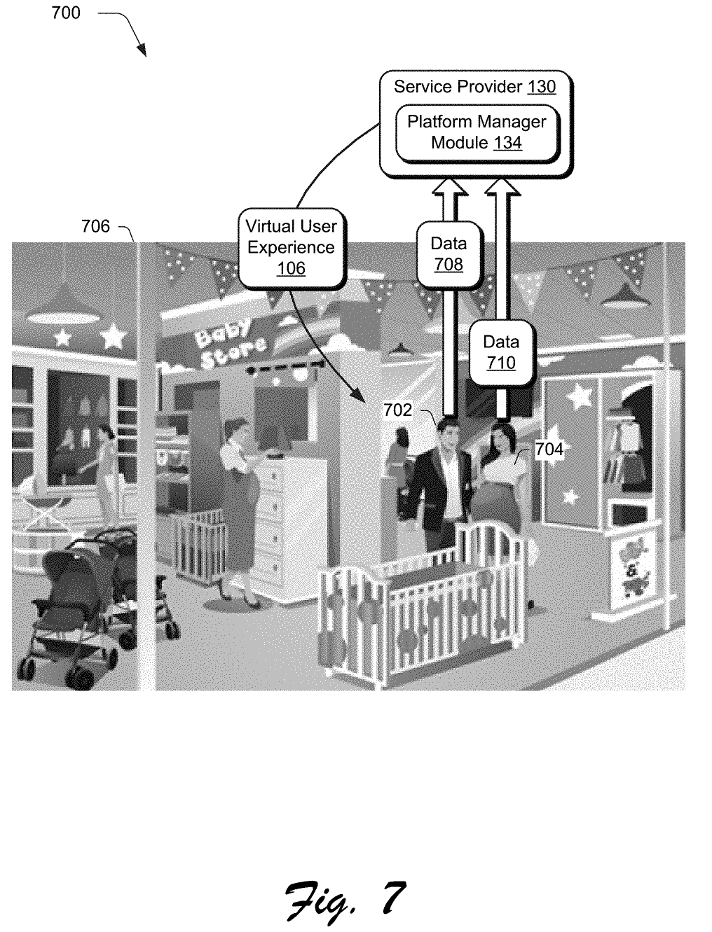

FIG. 7 depicts an example implementation 700 in which a virtual user experience selected for a first user 702 is based on proximity to a second user 704. The first and second users 702, 704 in this example are disposed within a physical store 706 that sells baby items. Upon entry into the physical store, data 708, 710 is communicated to the service provider 130 to cause selection of a virtual user experience 106. Techniques may also be enabled to have a user “opt out” or target particular virtual experiences as described in the following.

The data 708, 710, for instance, may identify the users. This identification is leveraged by the platform manager module 134 to determine an association of the first and second users 702, 704 to each other. Therefore, this may cause selection of a virtual user experience 106 for output to and sharing by both users, which may be different than if either user entered the physical store 706 alone. The first user 702, if visiting the store alone for instance, may be presented with a virtual user experience 106 having baby gift ideas. When visiting the store 706 with the second user 704, however, the virtual user experience 106 is selected for goods or services that are likely to be common to both users, such as to involve a major purchase like a crib. A variety of other usage scenarios are also contemplated which may vary based along with a wide range of physical environment conditions that may be used to trigger and select virtual user experiences as further described below.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7.

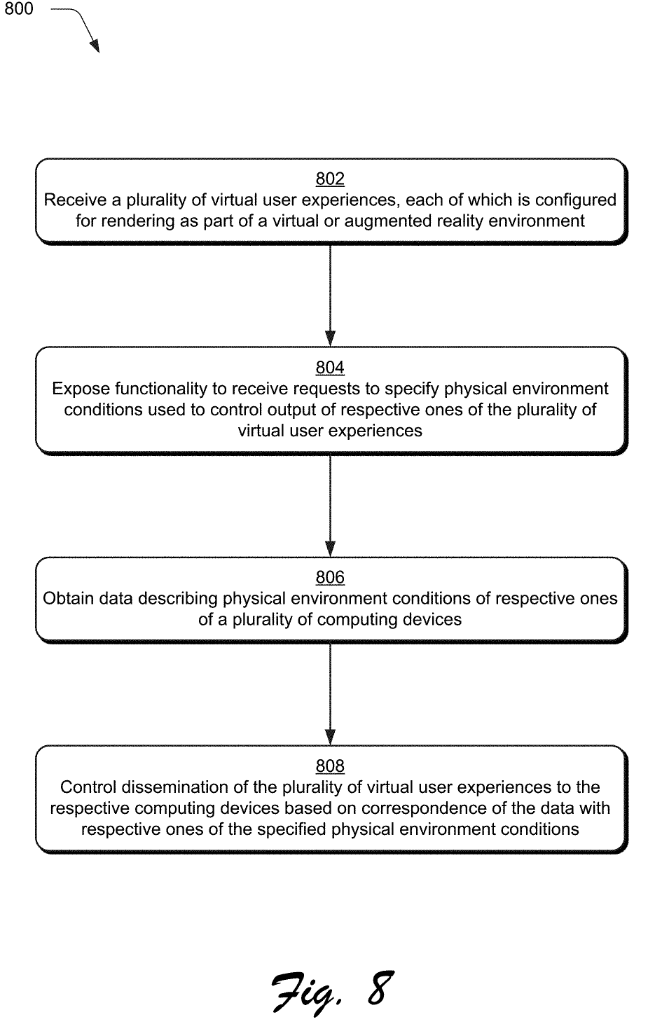

FIG. 8 depicts a procedure 800 in an example implementation in which virtual user experiences are associated with specified physical environment conditions to be used to control dissemination. A plurality of virtual user experiences is received, each of which is configured for rendering as part of a virtual or augmented reality environment (block 802). The service provider 130, for instance, may receive the plurality of virtual user experiences 106 from a variety of different entities, including marketers, store owners, manufacturers of goods or services, and so forth.

Functionality is exposed to receive requests to specify physical environment conditions used to control output of respective ones of the plurality of virtual user experiences (block 804). Continuing with the previous example, a user interface is output via which these entities specify physical environment conditions 410 to control when the experiences are disseminated. As part of this, bids may also be accepted that are used to calculate a monetary amount to be provided to the service provider 130 for this dissemination, e.g., as part of an online auction. For example, bids may be accepted to cause output of virtual user experiences based on detection of a particular physical object (e.g., object detection via a camera), physical environment conditions 410 of a user 412 (e.g., biometrics), physical surroundings 314, or any other condition detectable locally (by sensors 116) or remotely of the computing device 102.

Data is also obtained that describes physical environment conditions of respective ones of a plurality of computing devices (block 806). Computing device 102, for instance, may communicate data 404 describing physical environment conditions 410 detected using sensors 116 of the device. This may include conditions pertaining to the user 412, physical surroundings 414 of the computing device 102, and so forth.

Dissemination is controlled of the plurality of virtual user experiences to the respective computing devices based on correspondence of the data with respective ones of the specified physical environment conditions (block 808). Physical environment conditions 410 described by the data 404, for instance, may be matched to physical environment conditions specified to cause output of respective ones of the plurality of virtual user experiences 106. This may also be based, at least in part, on an amount bid to cause this output.

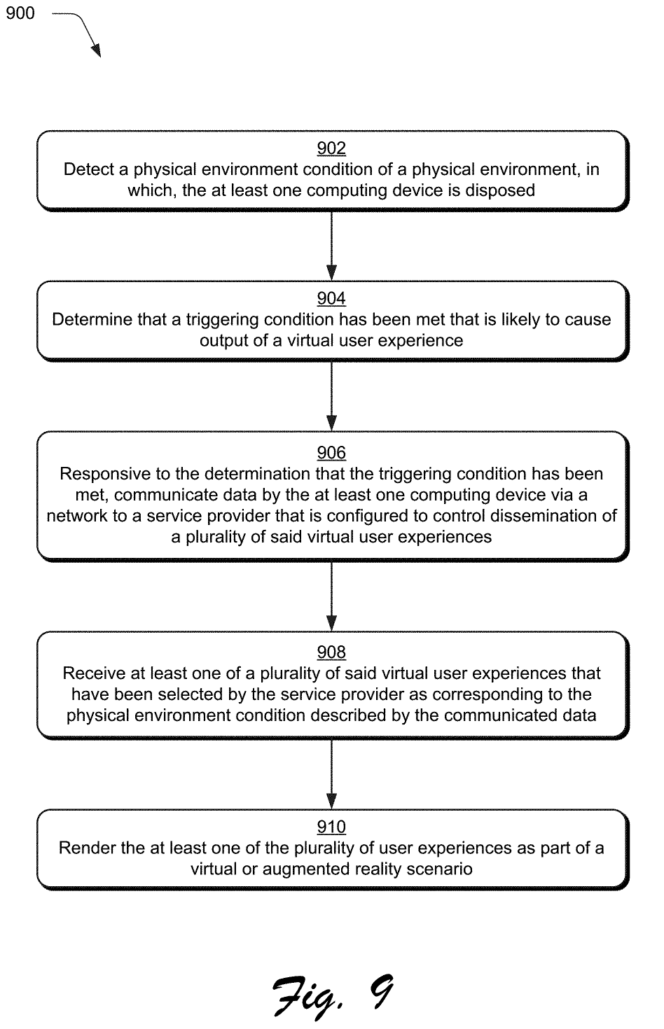

FIG. 9 depicts a procedure 900 in an example implementation in which dissemination is controlled of virtual user experiences. A physical environment condition 410 is detected of a physical environment, in which, a computing device is disposed (block 902). Sensors 116 of the computing device 102, for instance, may be used to detect a user 412, physical surroundings 414, and so forth.

A determination is made that a triggering condition has been met that is likely to cause output of a virtual user experience based on the detecting (block 904). Responsive to the determination that the triggering condition has been met, data is communicated by computing device via a network to a service provider that is configured to control dissemination of a plurality of virtual user experiences (block 906). The user experience manager module 104, from inputs received from the sensors 116, determines that a triggering condition has been met that is likely to cause output of a virtual user experience. This may be performed in a variety of ways, such as through comparison of the physical environment conditions 410 to a list of known triggers that are maintained locally by the computing device 102. In this way, the computing device 102 may first determine the triggering condition before communication of the data 404, thereby conserving network 132 resources.

At least one of a plurality of virtual user experiences are received that have been selected by the service provider as corresponding to the physical environment condition described by the communicated data (block 908). As before, the platform manager module 134 selects a virtual user experience 106 that corresponds to physical environment conditions 410 described by the data 404, which is the communicated via the network 132 to the user experience manager module 104. The at least one of the plurality of virtual user experiences is then rendered as part of virtual or augmented reality (block 910), e.g., by the display device 118 and which may also include audio. A variety of other examples are also contemplated as previously described.

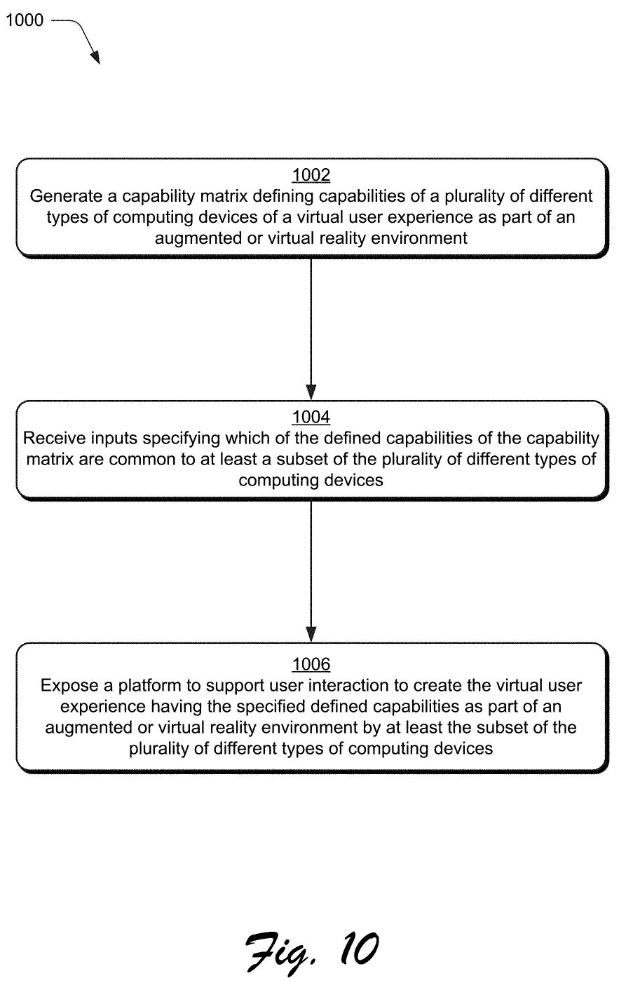

FIG. 10 depicts a procedure 1000 in an example implementation in which a platform is configured for creation of a virtual user experience. A capability matrix is generated that defines capabilities of a plurality of different types of computing devices of a virtual user experience as part of an augmented or virtual reality environment (block 1002). A user, for instance, may enter information manually regarding technical specifications (hardware and/or software) of different types of devices, may be downloaded and parsed from respective websites, and so forth.

Inputs are received that specify which of the defined capabilities of the capability matrix are common to at least a subset of the plurality of different types of computing devices (block 1004). A user, for instance, may proceed through manually through interaction with a user interface to select common capabilities. In another instance, this may be performed automatically and without user intervention by a computing device. Combinations of these instances are also contemplated, such as to generate a preliminary list of capabilities automatically by a computing device, which may then be refined manually by a user through interaction with a user interface.

A platform is exposed to support user interaction to create the virtual user experience having the specified defined capabilities as part of an augmented or virtual reality environment by at least the subset of the plurality of different types of computing devices (block 1006). The platform, for instance, may be configured as a template supporting the defined capabilities, to which, a user of the developer system 204 “codes to” to form the virtual user experience 106 and virtual object 108 employed as part of the virtual user experience 106. In this way, the user is provided with functionality to create a virtual user experience that is able to be output by these devices.

The platform may also include update and adaption functionality as part of the experience creation module 202. In an update example, the capability matrix 208 may be updated to reflect changes in types of devices, subsequently developed technologies, and so forth. The experience creation module 202 may then update the platform based on these changes, such as to permit usage on types of devices that causes the change to the capability matrix 208. The experience creation module 202 may also be configured to adapt a virtual user experience 106 for use by other types of computing devices, for which, the experience is not currently configured. This may be performed by leveraging defined relationships of capabilities within the capability matrix 208, a “path to action” conversion as described above, and so forth. A variety of other examples are also contemplated.

Example System and Device

FIG. 11 illustrates an example system generally at 1100 that includes an example computing device 1102 that is representative of one or more computing systems and/or devices that may implement the various techniques described herein. This is illustrated through inclusion of the user experience manager module 104. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1106 is illustrated as including memory/storage 1112. The memory/storage 1112 represents memory/storage capacity associated with one or more computer-readable media. The memory/storage component 1112 may include volatile media (such as random access memory (RAM)) and/or nonvolatile media (such as read only memory (ROM), Flash memory, optical disks, magnetic disks, and so forth). The memory/storage component 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device embodiment, implementation of functionality described herein may be distributed throughout the system 1100. For example, the functionality may be implemented in part on the computing device 1102 as well as via the platform 1116 that abstracts the functionality of the cloud 1114.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to manage a platform of a service provider to create a virtual user experience, a method implemented by at least one computing device, the method comprising:
generating, by the at least one computing device, a capability matrix defining capabilities of a plurality of different types of computing devices of a virtual user experience as part of an augmented or virtual reality environment;
receiving, by the at least one computing device, inputs specifying which of the defined capabilities of the capability matrix are common to at least a subset of the plurality of different types of computing devices; and
exposing, by the at least one computing device, a platform to support user interaction to create the virtual user experience having the specified defined capabilities as part of an augmented or virtual reality environment by at least the subset of the plurality of different types of computing devices.

2. The method as described in claim 1, further comprising adapting, by the least one computing device, the virtual user experience for use by at least one other type of the computing devices based on a defined relationship of the capabilities within the capability matrix.

3. The method as described in claim 2, wherein the adapting includes adapting the virtual user experience between virtual and augmented reality environment uses.

4. The method as described in claim 1, further comprising updating, by the least one computing device, the platform based on at least one change to the capability matrix.

5. The method as described in claim 4, wherein the subset of the plurality of different types of computing devices that support the virtual user experience changes based on the updating to include a type of the computing devices that corresponds to the change.

6. The method as described in claim 1, wherein the inputs are generated automatically and without user intervention by the at least one computing device.

7. The method as described in claim 1, wherein the inputs are originated by a user.

8. In a digital medium environment to manage a platform of a service provider to control dissemination of virtual user experiences, a method implemented by at least one computing device, the method comprising:
receiving, by the at least one computing device of the service provider, a plurality of virtual user experiences, each of which is configured for rendering as part of a virtual or augmented reality environment;
exposing, by the at least one computing device of the service provider, functionality to receive requests to specify physical environment conditions used to control output of respective ones of the plurality of virtual user experiences;
obtaining, by the at least one computing device of the service provider, data describing physical environment conditions of respective ones of a plurality of computing devices; and
controlling, by the at least one computing device of the service provider, the dissemination of the plurality of virtual user experiences to the respective computing devices based on correspondence of the data with respective ones of the specified physical environment conditions.

9. The method as described in claim 8, wherein the exposing of the functionality includes a user interface configured to receive an indication to be used as calculation of a monetary amount to be paid to the service provider to control dissemination of respective ones of the plurality of virtual user experiences with respect to specified physical environment conditions.

10. The method as described in claim 9, wherein the monetary amount is specified as a bid as part of an auction or permission to include an advertisement.

11. The method as described in claim 8, wherein the physical environment conditions pertain to physical characteristics of a user of respective ones of the plurality of computing devices.

12. The method as described in claim 8, wherein the physical environment conditions describe user interactions with physical goods or services.

13. The method as described in claim 8, wherein the physical environment conditions describe physical goods or services that are detected as proximal to a respective computing device of the plurality of computing devices.

14. The method as described in claim 13, wherein the physical goods or services are detected using object recognition from digital images captured of a physical environment in which the respective computing device is disposed.

15. The method as described in claim 8, wherein the physical environment conditions describe a location within a physical store by respective ones of the plurality of computing devices.

16. In a digital medium environment to output a virtual user experience, a method implemented by at least one computing device, the method comprising:
detecting, by the at least one computing device, a physical environment condition of a physical environment, in which, the at least one computing device is disposed;
determining, by the at least one computing device, that a triggering condition has been met that is likely to cause output of a virtual user experience based on the detecting;
responsive to the determining that the triggering condition has been met, communicating data by the at least one computing device via a network to a service provider that is configured to control dissemination of a plurality of said virtual user experiences;
receiving, by the at least one computing device, at least one of a plurality of said virtual user experiences that have been selected by the service provider as corresponding to the physical environment condition described by the communicated data; and
rendering, by the at least one computing device, the at least one of the plurality of virtual user experiences as part of virtual or augmented reality.

17. The method as described in claim 16, wherein the physical environment conditions describe user interactions with physical goods or services.

18. The method as described in claim 16, wherein the physical environment conditions describe physical goods or services that are detected as proximal to a respective computing device of the plurality of computing devices.

19. The method as described in claim 16, wherein the physical environment conditions describe a location within a physical store by respective ones of the plurality of computing devices.

20. The method as described in claim 16, wherein the at least one of the plurality of said virtual user experiences is selected by the service provider based at least in part on a monetary amount the service provider is to receive to control the dissemination of at least one of the plurality of said virtual user experiences with respective to the physical environment condition.
